(19) United States
(12) Patent Application Publication
(10) Pub. No.: US 2023/0122396 A1
(43) Pub. Date: Apr. 20, 2023

(54) ENABLING SHARED GRAPHICS AND COMPUTE HARDWARE ACCELERATION IN A VIRTUAL ENVIRONMENT

(71) Applicant: Microsoft Technology Licensing, LLC, Redmond, WA (US)

(72) Inventors: Jesse Tyler NATALIE, Redmond, WA (US); Iouri Vladimirovich TARASSOV, Bellevue, WA (US); Steve Michel PRONOVOST, Redmond, WA (US); Shawn Lee HARGREAVES, Seattle, WA (US); Ben Carson HILLIS, Seattle, WA (US); Brian David PERKINS, Woodinville, WA (US)

(21) Appl. No.: 18/083,730

(22) Filed: Dec. 19, 2022

Related U.S. Application Data
(63) Continuation of application No. 16/700,873, filed on Dec. 2, 2019.

(51) Int. Cl. G06F 9/455; G06F 9/38; G06F 9/54

(52) U.S. Cl. CPC G06F 9/45545; G06F 9/545; G06F 9/3877; G06F 9/45558

(57) ABSTRACT

The present disclosure relates to devices and methods for providing access to graphics or compute hardware acceleration to applications executing in a guest environment. The devices and methods may provide virtualization support to graphics or compute devices so that graphics or compute devices may be projected inside of a guest environment. The devices and methods may share the physical resources for graphics and compute hardware acceleration by coordinating the use of the graphics or compute hardware acceleration across a spectrum of devices, environments, or platforms.

### CROSS REFERENCE TO RELATED APPLICATIONS

This application is a Continuation of U.S. Application No. 16/700,873, filed Dec. 2, 2019, which is incorporated herein by reference in its entirety.

### BACKGROUND

In the WINDOWS Subsystem for LINUX (WSL) environment, LINUX applications may run on a WINDOWS computer. However, these applications may not have access to any hardware acceleration for 3D rendering or parallel compute workloads. In the WSL environment, either there is no LINUX kernel to host device drivers, or there are no devices that are made available to the LINUX kernel to host a driver. As such, LINUX applications may not be able to perform graphics or compute processes.

These and other problems exist in providing access to graphics and compute acceleration hardware to applications executing in a virtual environment.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One example implementation relates to a computer device. The computer device may include a memory, at least one processor; at least one hardware acceleration device, a host operating system in communication with the memory, the at least one processor, and the at least one hardware acceleration device, wherein the host operating system hosts a guest environment and the host operating system is operable to: receive a request, from a guest application operating in the guest environment, to use the at least one hardware acceleration device; receive another request from a second application to use the at least one hardware acceleration device; coordinate the use of the at least one hardware acceleration device between the guest application and the second application; and send a received response from the at least one hardware acceleration device to the guest environment.

Another example implementation relates to a method. The method may include receiving a request, from a guest application operating in a guest environment on a computer device, to use at least one hardware acceleration device on the computer device. The method may include receiving another request from a second application to use the at least one hardware acceleration device. The method may include coordinating the use of the at least one hardware acceleration device between the guest application and the second application. The method may include sending a received response from the at least one hardware acceleration device to the guest environment.

Another example implementation relates to a computer-readable medium storing instructions executable by a computer device. The computer-readable medium may include at least one instruction for causing the computer device to receive a request, from a guest application operating in a guest environment, to use at least one hardware acceleration device on the computer device. The computer-readable medium may include at least one instruction for causing the computer device to receive another request from a second application to use the at least one hardware acceleration device. The computer-readable medium may include at least one instruction for causing the computer device to coordinate the use of the at least one hardware acceleration device between the guest application and the second application. The computer-readable medium may include at least one instruction for causing the computer device to send a received response from the at least one hardware acceleration device to the guest environment.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In the drawings:

FIG. 1 is a schematic block diagram of an example computer device for use with providing access to hardware acceleration devices in accordance with an implementation.

FIG. 2 is a schematic block diagram of an example computer device for use with providing graphics or compute resources to a WINDOWS subsystem for LINUX (WSL) environment with an emulation of a LINUX kernel in accordance with an implementation.

FIG. 3 is a schematic block diagram of an example computer device for use with providing graphics or compute resources to a WINDOWS subsystem for LINUX (WSL) environment operating in a virtual machine with a LINUX graphics kernel in accordance with an implementation.

FIG. 4 is a flow diagram of an example method for managing access to hardware acceleration devices operating on a computer device in accordance with an implementation.

FIG. 5 is a flow diagram of an example method for providing access to hardware acceleration devices to a WINDOWS subsystem for LINUX (WSL) environment with an emulation of a LINUX kernel in accordance with an implementation.

FIG. 6 is a flow diagram of an example method for providing access to graphics and compute acceleration hardware to a WINDOWS subsystem for LINUX (WSL) environment operating in a virtual machine with a LINUX graphics kernel in accordance with an implementation.

FIG. 7 illustrates certain components that may be included within a computer system.

### DETAILED DESCRIPTION

The present disclosure generally relates to devices and methods for providing access to graphics and compute hardware acceleration on a computer device to applications executing in a virtual environment. The present disclosure may share the graphics and/or compute hardware acceleration across a spectrum of devices, environments, and/or platforms. The present disclosure may provide virtualization support to graphics and/or compute devices so that graphics and/or compute devices may be projected inside of a LINUX environment, such as, but not limited to, a WINDOWS subsystem for LINUX (WSL) environment.

In the WSL environment, LINUX applications may run on a WINDOWS computer, however, LINUX applications may not have access to any graphics and/or compute hardware acceleration for 3D rendering or parallel compute workloads. On a WINDOWS computer or a LINUX computer, applications may use a graphics application programming interface (API), such as, but not limited to, Direct3D, Open Graphics Library (OpenGL), Open Computing Language (OpenCL), or Vulkan to access the graphics and/or compute hardware, with the help of a driver for the graphics and/or compute hardware.

In the WSL environment, either there is no LINUX kernel to host device drivers, or there are no devices that are made available to the LINUX kernel on which to host a driver. Additionally, modern graphics drivers generally consist of two pieces: a traditional device driver which lives in the kernel of the operating system, along with a user mode component which does majority of the work associated with producing workloads that are fed to the hardware.

Currently, one option to expose a GPU to a LINUX virtual machine running on a WINDOWS host, the GPU is made invisible to the WINDOWS host. The current solution does not work well for developer scenarios where the computer may only have one graphics device, and the host operating system requires access to the graphics device. Another current option for exposing a GPU to a LINUX virtual machine running on a WINDOWS host is to use a technique known as GPU partitioning, where the host OS gives up access to a portion of the resources (memory and compute units) of the device, and makes that portion exclusively available for the guest virtual machine. Using either of the current solutions for hardware access requires an independent hardware vendor (IHV)-provided LINUX kernel driver capable of driving the hardware in the virtualized environment and/or prevents the host operating system from accessing the hardware.

The present disclosure enables dynamic sharing of hardware acceleration resources on a process-by-process basis seamlessly between host processes and guest processes. In an implementation, the WINDOWS graphics kernel may coordinate the sharing of the hardware acceleration resources. In an implementation, the IHV kernel driver may exist on the WINDOWS host operating system, and canonical implementations of graphics runtimes may be provided that communicate with drivers along well-defined interfaces.

The present disclosure may expose a graphics kernel into the LINUX environment. In an implementation, a WINDOWS graphics kernel, such as, but not limited to, DxgKrnl and DxgMms, may be exposed into the WSL environment. By exposing the graphics kernel into the LINUX environment, access to graphics and compute resources in the cloud may be provided for developers who want to run workloads in LINUX containers.

In an implementation, the WSL environment may not include a LINUX kernel, but rather an emulation of a LINUX kernel on top of the WINDOWS NT kernel (referred throughout as “WSL 1”). For example, in the WSL 1 environment, a virtual device may be exposed via a kernel emulation layer. The kernel emulation layer exposes a set of IOCtl functions that LINUX applications in a user mode may use to communicate with the WINDOWS graphics subsystem. The implementation may provide a user mode library which provides a structured API on top of the IOCtls.

In another implementation, the WSL environment may include a LINUX kernel that is hosted in a virtual machine (referred throughout as “WSL 2”). For example, in the WSL 2 environment, a kernel mode driver may be loaded into the LINUX kernel that exposes a set of IOCtl functions, and communicates with the WINDOWS graphics subsystem of the host WINDOWS computer via a paravirtualization technology.

In an implementation, user mode components for LINUX, consisting of, for example, executable and linkable format (ELF) shared objects (.so files) that expose APIs that WINDOWS application and WINDOWS driver developers are familiar with, may be provided to the WSL environment to expedite and ease the porting of WINDOWS based graphics and/or compute applications and user mode drivers to the WSL environment. Example APIs include, but are not limited to, DirectX12, DXCore, DirectML, and/or WinML.

As such, the present disclosure may allow applications operating in a virtual or other guest environment, such as, but not limited to, WSL 1 or WSL 2, access to graphics processing. The present disclosure may provide dynamic sharing of graphic hardware acceleration resources seamlessly between host processes and guest processes. The present disclosure may also provide similar performance for graphics processing to applications operating in the guest environments as applications operating in the host environments.

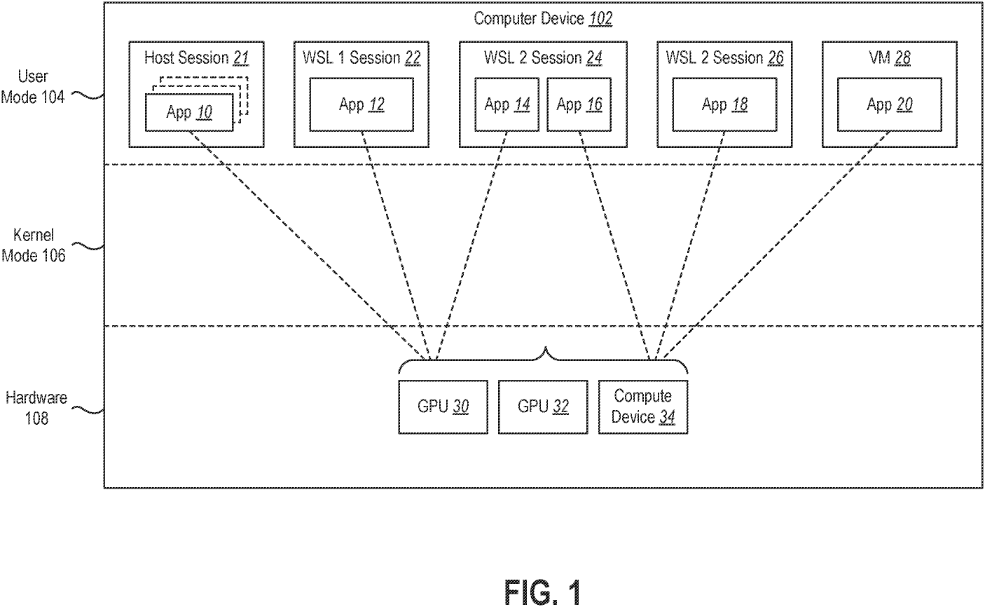

Referring now to FIG. 1, illustrated is an example computer device 102 for use with dynamic sharing of hardware resources, such as, graphics and compute hardware acceleration on computer device 102 across a spectrum of environments and/or platforms. Computer device 102 may include a user mode 104, a kernel mode 106, and a hardware 108 area. The hardware area 108 may include any number of graphics and/or compute acceleration devices. For example, hardware area 108 may include a plurality of graphics processing units (GPUs), such as an integrated GPU or a discrete GPU, in addition to a plurality of compute devices. Computer device 102 may include an operating system (“the host operating system”) that hosts a plurality of virtual machines (VM) 28 and/or containers. In an implementation, the host operating system may be WINDOWS.

In addition, the host operating system may host one or more LINUX operating system environments, such as, but not limited to, a WINDOWS subsystem for LINUX (WSL) environment. In an implementation, the WSL environment may not include a LINUX kernel, but rather an emulation of a LINUX kernel on top of the WINDOWS NT kernel (referred throughout as “WSL 1”). For example, in the WSL 1 environment, a virtual device may be exposed via a kernel emulation layer. In another implementation, the WSL environment may include a LINUX kernel that is hosted in a virtual machine (referred throughout as “WSL 2”). In the WSL environment, LINUX applications may run on a computer device 102, however, LINUX applications may not have access to any hardware on computer device 102.

User mode 104 may include a plurality of sessions operating on computer device 102. A host session 21 may include one or more applications 10 operating on the host operating system. Applications 10 may want to use or access one or more graphics or compute hardware acceleration on computer device, such as, but not limited to, GPU 30, GPU 32, and/or compute device 34 for one or more graphics or compute processes. Example graphics or compute processes may include, but are not limited to, direct compute workloads, render workloads, raytracing workloads, machine learning training, and/or computational frameworks.

User mode 104 may also include a WSL 1 session 22 with one or more applications 12 operating on the WSL 1 session 22. For example, applications 12 may be LINUX applications. Applications 12 may want to use or access one or more of GPU 30, GPU 32, and/or compute device 34 for one or more graphics or compute processes.

User mode 104 may also include a WSL 2 session 24 with application 14 and application 16 operating on the WSL 2 session 24. For example, applications 14, 16 may be LINUX applications. Applications 14, 16 may also want to use or access one or more of GPU 30, GPU 32, and/or compute device 34 for one or more graphics or compute processes. User mode 104 may also include another WSL 2 Session 26 with one or more applications 18 operating on the WSL 2 Session 26. For example, applications 18 may be LINUX applications. Application 18 may want to use or access one or more of GPU 30, GPU 32, and/or compute device 34 for one or more graphics or compute processes.

In addition, user mode 104 may include a virtual machine (VM) 28 with one or more applications 20 operating on VM 28. Applications 20 may also want to use or access one or more of GPU 30, GPU 32, and/or compute device 34.

Computer device 102 may provide access to hardware acceleration resources (e.g., GPU 30, GPU 32, and/or compute device 34) to host processes (e.g., applications 10) and guest processes (e.g., applications 12, 14, 16, 18, 20). In addition, computer device 102 may enable dynamic sharing of hardware acceleration resources (e.g., GPU 30, GPU 32, and/or compute device 34) on a process-by-process basis seamlessly between host processes (e.g., applications 10) and guest processes (e.g., applications 12, 14, 16, 18, 20). For example, a host application 10 may use a compute device 34 for a local calculation and computer device 102 may simultaneously share the compute device 34 with one or more guest applications 12, 14, 16, 18, 20.

The data from host applications 10 and guest applications 12, 14, 16, 18, 20 may be directly shared with the hardware acceleration resources with direct mapping of the hardware acceleration resources. Computer device 102 may provide the guest applications 12, 14, 16, 18, 20 with device memory management and scheduling support allowing for efficient sharing of hardware acceleration resources across a plurality of devices, environments, and/or platforms.

As such, computer device 102 may provide similar performance for graphics processing to applications operating in the guest environments as applications operating in the host environments. Thus, computer device 102 may provide software developers with access to graphics and compute resources in the cloud.

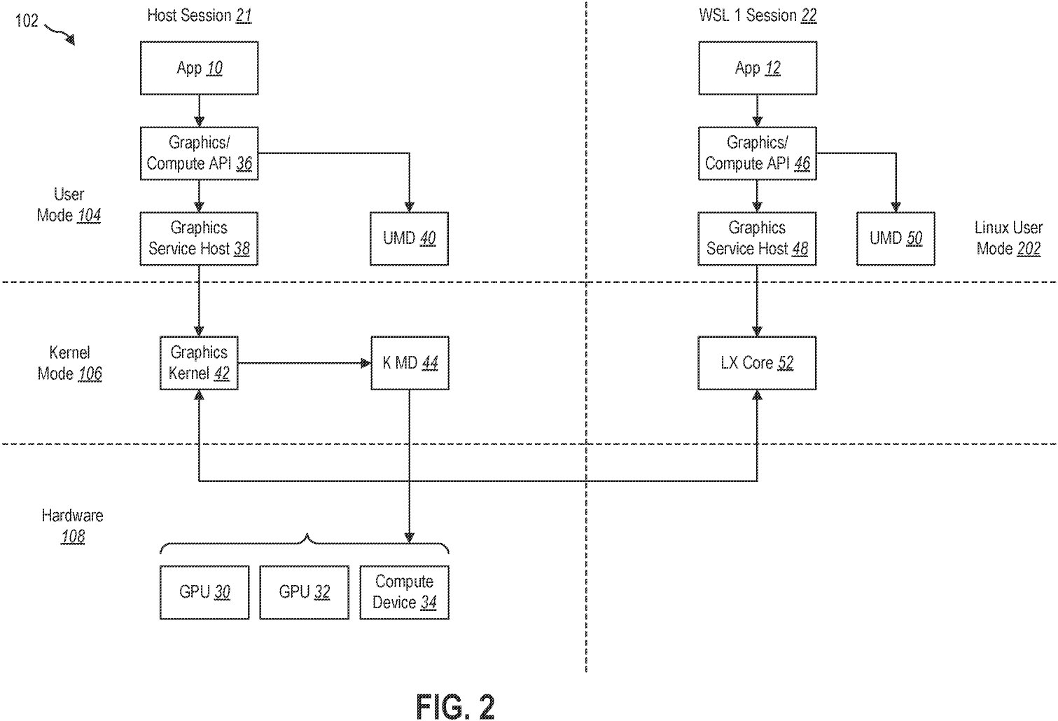

Referring now to FIG. 2, illustrated is an example of computer device 102 providing graphics and/or compute resources to host applications and guest applications operating in a WSL 1 environment, e.g., WSL 1 session 22. The WSL 1 environment may mimic a LINUX kernel. An emulation of a LINUX kernel may be provided on top of the host operating system kernel of computer device 102. As such, in the WSL 1 environment, the LINUX processes may coexist with the host processes on a shared kernel. Moreover, hardware virtualization may not be required for the WSL 1 environment.

User mode 104 may include a host session 21 with one or more applications 10 operating on the host operating system. For example, applications 10 may operate on a WINDOWS operating system. Application 10 may send a request to a graphics and/or compute application programming interface (API) 36 to use one or more hardware acceleration resources, such as, GPU 30, GPU 32, and/or compute device 34. In an implementation, the graphics/compute API 36 may include a WINDOWS D3D12 API.

Graphics or compute API 36 may send the request to a graphics service host 38 and/or a user mode driver 40 to generate one or more rendering commands for the hardware acceleration devices. In an implementation, graphics service host 38 may include a WINDOWS DXCore component that may provide access to the graphics kernel 42.

The graphics service host 38 may send the request to a graphics kernel 42. In an implementation, the graphics kernel 42 may include a WINDOWS DxgKrnl. The graphics kernel 42 may transmit the request, e.g., rendering commands, to a kernel mode driver (KMD) 44 and the kernel mode driver 44 may coordinate the access to one or more of GPU 30, GPU 32, and/or compute device 34 for processing the requests.

In the WSL 1 environment, a LINUX user mode 202 may include a graphics/compute API 46 interface, a graphics service host 48 interface and a user mode driver 50 interface may be exposed into the WSL 1 session 22 so that applications 12 operating in the WSL1 session 22 may send requests to use one or more hardware acceleration resources on computer device 102 (e.g., GPU 30, GPU 32, and/or compute device 34). In an implementation, graphics/compute API 46, graphics service host 48, and/or user mode driver 50 may consist of ELF shared objects (.so files) which expose APIs that WINDOWS application and WINDOWS driver developers are familiar with; to expedite and ease the porting of WINDOWS based graphics/compute applications and user mode drivers to the WSL 1 environment.

Graphics/compute API 46 may enable applications 12 operating in the WSL 1 session 21, to perform a variety of graphic processing, such as, but not limited to, direct compute workloads, render workloads, raytracing workloads, machine learning training, and/or computational frameworks. In an implementation, graphics/compute API 46 may include a WINDOWS D3D12 API. In an implementation, graphics service host 48 may include a WINDOWS DXCore component.

In addition, a virtual device may be exposed into WSL 1 session 22 via a kernel emulation layer 52, also referred throughout as LX Core 52. The kernel emulation layer 52 exposes a set of functions that applications 12 in LINUX user mode 202 may use to communicate with the graphics subsystem of the host session 21 from the LINUX user mode 202. For example, during system initialization, LX Core 52 communicates directly with WINDOWS DxgKrnl to exchange a set of function pointers, which are the same ones that WINDOWS applications use to communicate with DxgKml. As such, call flow routing through LX Core 52 may be identical to call flows which originate from WINDOWS applications.

LX Core 52 may send the requests received from application 12 to graphics kernel 42. Graphics kernel 42 may transmit the request to the kernel mode driver 44 and kernel mode driver 44 may provide access to one or more of GPU 30, GPU 32, and/or compute device 34.

Requests received from application 12 may appear to graphics kernel 42 as local processes to host session 21. As such, graphics kernel 42 may be unaware that the requests originated from applications 12 in the WS1 session 22 environment. Graphics kernel 42 may coordinate the access to GPU 30, GPU 32, and/or compute device 34 between the host applications 10 and/or guest applications 12.

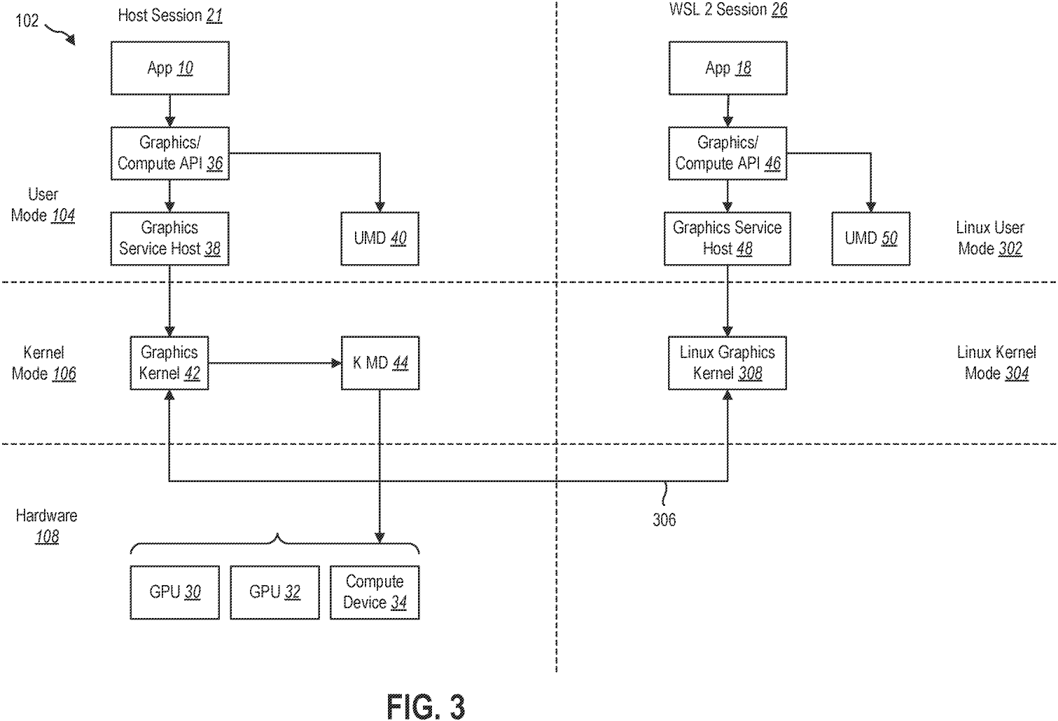

Referring now to FIG. 3, illustrated is an example of computer device 102 providing access to hardware acceleration resources to guest applications 18 operating in a WSL 2 environment, e.g., WSL 2 session 26. The WSL 2 environment may include a LINUX kernel hosted in a virtual machine. As such, the WSL 2 environment uses an actual LINUX kernel, instead of an emulation of a LINUX kernel. In the WSL 2 environment instead of the LINUX processes operating on a shared host kernel with the host processes, the entire LINUX environment is run within a virtual machine/container hosted by the host operating system.

For example, the WSL 2 environment may include a LINUX user mode 302 with one or more applications 18 operating in the WSL 2 environment. The LINUX user mode 302 may also include a graphics/compute API 46, a graphics service host 48, and a user mode driver 50. In an implementation, graphics/compute API 46, graphics service host 48, and/or user mode driver 50 may consist of ELF shared objects (.so files) which expose APIs that WINDOWS application and WINDOWS driver developers are familiar with; to expedite and ease the porting of WINDOWS based graphics/compute applications and user mode drivers to the WSL 2 environment.

The WSL 2 environment may also include a LINUX kernel mode 304 with a LINUX graphics kernel 308. The LINUX graphics kernel 308 may be loaded into the LINUX kernel mode 304. In an implementation, the LINUX graphics kernel 308 may be implemented as a LINUX kernel driver. The LINUX graphics kernel 308 may expose the same set of IOCtl functions, and communicates with the WINDOWS graphics subsystem of the host WINDOWS PC via a paravirtualization technology or protocol. As such, the LINUX user mode 302 may be used without modification.

The LINUX graphics kernel 308 may provide access to the graphics kernel 42 on computer device 102 via a communication channel 306. Communication channel 306 may include a VM bus that crosses over the virtual machine boundary to graphics kernel 42. In an implementation, communication channel 306 may support a WINDOWS Display Driver Model (WDDM) GPU using a WDDM paravirtualization protocol. The WDDM paravirtualization protocol may send messages across the VM bus in both directions, so that messages sent by the guest (e.g., LINUX graphics kernel 308) may be received and interpreted by the host (e.g., graphics kernel 42), and the host can respond with messages. Thus, the host graphics kernel 42 and the guest LINUX graphics kernel 308 may communicate and cooperate to provide access to the hardware resources to applications 18 in the guest environment (e.g., WSL 2 session 22).

Graphics kernel 42 may transmit the request to the kernel mode driver 44 and kernel mode driver 44 may provide access to one or more of GPU 30, GPU 32, and/or compute device 34. Requests received from application 18 may appear to graphics kernel 42 as any other guest processes. As such, graphics kernel 42 may be unaware that the requests originated from applications 18 in the WSL 2 session 22 LINUX environment.

As discussed in reference to FIG. 2, host session 21 may have one or more applications 10 in communication with a graphics/compute API 36, graphics service host 38, and a user mode driver 40. Applications 10 may also send requests to graphics kernel 42 to use one or more hardware acceleration resources, such as, GPU 30, GPU 32, and/or compute device 34.

Graphics kernel 42 may coordinate the access to GPU 30, GPU 32, and/or compute device 34 between the host applications 10 and/or guest applications 18. For example, a host application 10 may use GPU 32 for a local graphics operation and graphics kernel 42 may simultaneously share GPU 32 with guest application 18 for use with a graphics operation for guest application 18.

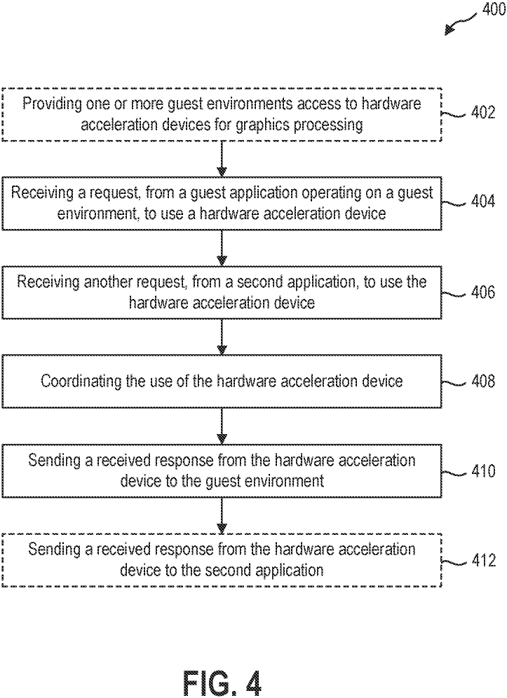

Referring now to FIG. 4, an example method 400 may be used by a computer device 102 (FIG. 1) to manage access to one or more hardware acceleration devices operating on computer device 102. The actions of method 400 may be discussed below in reference to the architecture of FIGS. 1-3.

At 402, method 400 may optionally include providing one or more guest environments access to hardware acceleration devices for graphics processing. A host operating system on computer device 102 may expose one or more graphic interfaces or components into one or more guest environments. Guest environments may include, but are not limited to, a virtual machine, a WSL environment with an emulation of a LINUX kernel (“WSL 1”), and/or a WSL environment operating in a virtual machine with a LINUX graphics kernel (“WSL 2”). In addition, host operating system on computer device 102 may establish one or more communication channels between the guest environments and the hardware acceleration devices operating on the host operating system so that the guest applications 12, 14, 16, 18, 20 running in the guest environments may communicate with a graphics kernel 42 operating on computer device 102.

At 404, method 400 may include receiving a request from a guest application operating on a guest environment to use a hardware acceleration device. A graphics kernel 42 may receive one or more requests from one or more guest applications 12, 14, 16, 18, 20 to use one or more hardware acceleration devices on computer device 102. For example, the hardware acceleration devices may include one or more GPUs (e.g., GPU 30, GPU 32) and/or one or more compute devices 34. In addition, the requests may be for graphics and/or compute processing, such as, but not limited to, direct compute workloads, render workloads, raytracing workloads, machine learning training, and/or computational framework. Requests received by graphics kernel 42 from application 12 may appear as local processes to the host. As such, graphics kernel 42 may be unaware that the requests originated from applications 12 in the guest environment.

At 406, method 400 may include receiving another request from a second application to use the hardware acceleration device. The second application may include a host application 10 operating on a host environment to use the hardware acceleration device (e.g., GPU 30, GPU 32, and/or compute device 34). In addition, the second application may include another guest application 12, 14, 16, 18, 20 operating on guest environment or a different guest environment. For example, graphics kernel 42 may receive one or more requests from one or more host applications 10 to use one or more hardware acceleration devices (e.g., GPU 30, GPU 32, and/or compute devices 34). The other request may be for the same hardware acceleration device (e.g., GPU 30, GPU 32, and/or compute device 34) requested for use by guest applications 12, 14, 16, 18, 20 or a different hardware acceleration device (e.g., GPU 30, GPU 32, and/or compute device 34).

At 408, method 400 may include coordinating the use of the hardware acceleration device. Graphics kernel 42 may coordinate the use of the hardware acceleration devices (e.g., GPU 30, GPU 32, and/or compute device 34) between the guest application and the second application 12, 14, 16, 18, 20. Graphics kernel 42 may enable dynamic sharing of GPU 30, GPU 32, and/or compute device 34 on a process-by-process basis seamlessly between the second application and guest applications 12, 14, 16, 18, 20. For example, a host application 10 may use GPU 30 for a local graphics processing and computer device 102 may simultaneously share GPU 30 and GPU 32 with one or more guest applications 12, 14, 16, 18, 20.

The data from the second application and guest applications 12, 14, 16, 18, 20 may be directly shared with the hardware acceleration resources with direct mapping of the hardware acceleration resources. Computer device 102 may provide the guest applications 12, 14, 16, 18, 20 with device memory management and scheduling support allowing for efficient sharing of hardware acceleration resources across the plurality of devices, environments, and/or platforms.

Graphics kernel 42 may transmit the request to the kernel mode driver 44 and kernel mode driver 44 may provide access to one or more of GPU 30, GPU 32, and/or compute device 34.

At 410, method 400 may include sending a received response from the hardware acceleration device to the guest environment. Graphics kernel 42 may transmit the received response from GPU 30, GPU 32, and/or compute device 34 to the guest environment.

At 412, method 400 may include sending a received response from the hardware acceleration device to the second application. Graphics kernel 42 may transmit the received response from GPU 30, GPU 32, and/or compute device 34 to the second application.

Method 400 may be used to provide similar performance for graphics processing to applications operating in the guest environments as applications operating in the host environments. As such, method 400 may provide software developers with more choices for environments to use graphics workloads.

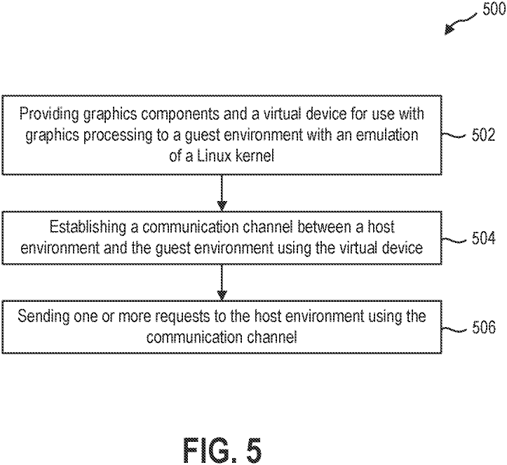

Referring now to FIG. 5, method 500 may be used by computer device 102 (FIG. 1) to provide a WSL 1 environment hosted by a host operating system on computer device 102 access to hardware acceleration devices on computer device 102. The actions of method 500 may be discussed below in reference to the architecture of FIGS. 1-3.

At 502, method 500 may include providing graphics components and a virtual device for use with graphics processing to a guest environment with an emulation of a LINUX kernel. For example, the guest environment may be a WSL 1 environment (e.g., WSL 1 session 21) that mimics a LINUX kernel. An emulation of a LINUX kernel may be provided on top of the host operating system kernel.

A LINUX user mode 202 may include a graphics/compute API 46 interface, a graphics service host 48 interface and a user mode driver 50 interface may be exposed into the WSL 1 session 22 so that applications 12 operating in the WSL1 session 22 may send requests to use one or more acceleration hardware resources on computer device 102 (e.g., GPU 30, GPU 32, and/or compute device 34). In an implementation, graphics/compute API 46, graphics service host 48, and/or user mode driver 50 may consist of ELF shared objects (.so files) which expose APIs that WINDOWS application and WINDOWS driver developers are familiar with; to expedite and ease the porting of WINDOWS based graphics/compute applications and user mode drivers to the WSL 1 environment.

In addition, a virtual device may be exposed into WSL 1 session 22 via a kernel emulation layer. The kernel emulation layer, also referred to throughout as LX Core 52, exposes a set of functions that applications 12 in user mode 104 may use to communicate with the graphics subsystem of a host environment.

At 504, method 500 may include establishing a communication channel between a host environment and the guest environment using the virtual device. LX Core 52 may establish a communication channel that allows applications 12 to communicate with graphics kernel 42. In an implementation, during system initialization, LX Core 52 communicates directly with WINDOWS DxgKrnl to exchange a set of function pointers, which are the same ones that WINDOWS applications use to communicate with DxgKrnl. As such, call flow routing through LX Core 52 may be identical to call flows which originate from WINDOWS applications.

At 506, method 500 may include sending one or more requests to the host environment using the communication channel. LX Core 52 may send the requests received from application 12 to graphics kernel 42. Graphics kernel 42 may transmit the request to the kernel mode driver 44 and kernel mode driver 44 may provide access to one or more of GPU 30, GPU 32, and/or compute device 34.

As such, method 500 may allow guest applications executing in a WSL 1 environment the ability to use graphics and/or compute hardware acceleration for one or more graphics or compute processes.

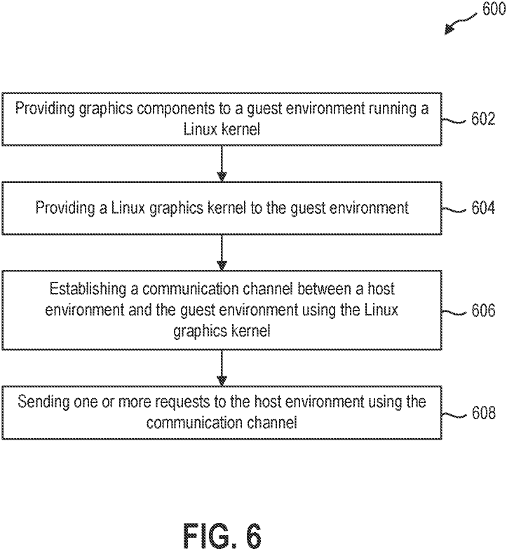

Referring now to FIG. 6, method 600 may be used by computer device 102 (FIG. 1) to provide a WSL 2 environment (e.g., WSL 2 session 24, WSL 2 session 26) hosted by a host operating system on computer device 102 access to hardware acceleration devices on computer device 102. The actions of method 600 may be discussed below in reference to the architecture of FIGS. 1-3. The WSL 2 environment may run within a virtual machine/container hosted by the host operating system.

At 602, method 600 may include providing graphics components to a guest environment running a LINUX kernel. The WSL 2 environment may include a LINUX user mode 302 with one or more applications 18 operating in the WSL 2 environment. The LINUX user mode 302 may also include a graphics/compute API 46, a graphics service host 48, and a user mode driver 50. In an implementation, graphics/compute API 46, graphics service host 48, and/or user mode driver 50 may consist of ELF shared objects (.so files) which expose APIs that WINDOWS application and WINDOWS driver developers are familiar with, to expedite and ease the porting of WINDOWS based graphics/compute applications and user mode drivers to the WSL 2 environment.

At 604, method 600 may include providing a LINUX graphics kernel to the guest environment. The WSL 2 environment may also include a LINUX kernel mode 304 with a LINUX graphics kernel 308. The LINUX kernel driver 308 and the LINUX graphics kernel 308 may be loaded into the LINUX kernel mode 304. In an implementation, the LINUX graphics driver 308 may expose the same set of IOCtl functions, and communicates with the WINDOWS graphics subsystem of the host WINDOWS PC via a paravirtualization technology. As such, the LINUX user mode 302 may be used without modification.

At 606, method 600 may include establishing a communication channel between a host environment and the guest environment using the LINUX graphics kernel. The LINUX graphics kernel 308 may communicate with the graphics kernel 42 on computer device 102 via communication channel 306. Communication channel 306 may include a VM bus that crosses over the virtual machine boundary to graphics kernel 42. In an implementation, communication channel 306 may support a WINDOWS Display Driver Model (WDDM) GPU using a WDDM paravirtualization protocol. The WDDM paravirtualization protocol may send messages across the VM bus in both directions, so that messages sent by the guest (e.g., LINUX graphics kernel 308) may be received and interpreted by the host (e.g., graphics kernel 42), and the host can respond with messages. Thus, the host graphics kernel 42 and the guest LINUX graphics kernel 308 may communicate and cooperate to provide access to the hardware resources to applications 18 in the guest environment (e.g., WSL 2 session 22).

At 608, method 600 may include sending one or more requests to the host environment using the communication channel. The LINUX graphics kernel 308 may send one or more requests received from application 18 to the graphics kernel 42 using communication channel 306.

Graphics kernel 42 may transmit the request to the kernel mode driver 44 and kernel mode driver 44 may provide access to one or more of GPU 30, GPU 32, and/or compute device 34. Requests received from application 18 may appear to graphics kernel 42 as any other guest processes. As such, graphics kernel 42 may be unaware that the requests originated from applications 18 in a LINUX environment.

Method 600 may be used to provide access to graphics and compute resources in a LINUX environment, and thus, allowing software developers to run graphics workloads in LINUX containers.

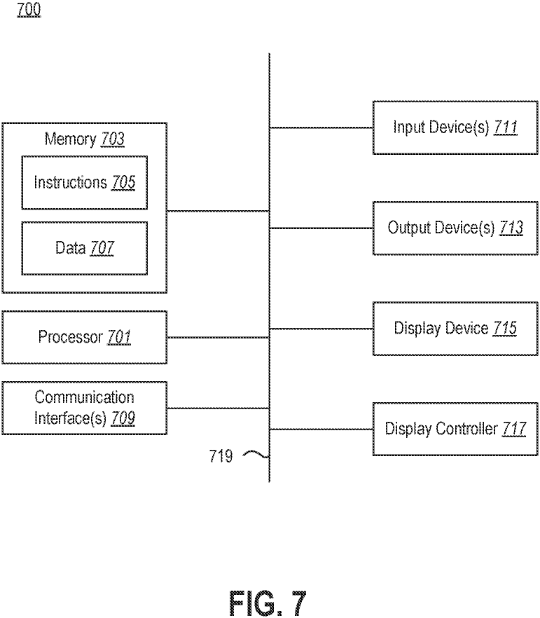

FIG. 7 illustrates certain components that may be included within a computer system 700. One or more computer systems 700 may be used to implement the various devices, components, and systems described herein.

The computer system 700 includes a processor 701. The processor 701 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker and a printer. One specific type of output device that is typically included in a computer system 700 is a display device 715. Display devices 715 used with implementations disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For the sake of clarity, the various buses are illustrated in FIG. 7 as a bus system 719.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementation s that also incorporate the recited features. For example, any element or feature described in relation to an implementation herein may be combinable with any element or feature of any other implementation described herein, where compatible.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A computer device, comprising:
a memory;
a hardware acceleration device; and
a processor in communication with the memory and the hardware acceleration device, wherein the processor is operable to:
host a host operating system;
host a first guest environment with a first guest operating system that is different from the host operating system, wherein the first guest environment includes an emulation of a graphics kernel;
host a second guest environment with a second guest operating system that is different from the host operating system, wherein the second guest environment includes a graphics kernel running within a virtual machine hosted by the host operating system;
receive a first request, from a first guest application operating in the first guest environment, to use the hardware acceleration device for graphics operations;
receive a second request, from a second guest application operating in the second guest environment, to use the hardware acceleration device for graphics operations;
receive a third request from an application operating in the host to use the hardware acceleration device for local graphics operations; and
coordinate use of the hardware acceleration device between the first guest application, the second guest application, and the application.

2. The computer device of claim 1, wherein the hardware acceleration device is a graphics device or a compute device.

3. The computer device of claim 1, wherein the processor is further operable to:
coordinate the use of the hardware acceleration device by simultaneously sharing the hardware acceleration device with the first guest application, the second guest application, and the application.

4. The computer device of claim 1, wherein the processor is further operable to:
coordinate the use of the hardware acceleration device on a process-by-process basis between the first guest application, the second guest application, and the application.

5. The computer device of claim 1, wherein the processor is further operable to:
host additional guest environments, wherein the additional guest environments run graphics workloads in the additional guest environments; and
receive requests from applications operating in the additional guest environments to use the hardware acceleration device.

6. The computer device of claim 5, wherein the processor is further operable to:
coordinate the use of the hardware acceleration device between the applications in the additional guest environments, the first guest application, the second guest application, and the application.

7. A method, comprising:
receiving, at a graphics kernel on a computer device, a first request from a first application operating in a guest environment on the computer device to use a hardware acceleration device on the computer device, wherein the guest environment has a guest operating system;
receiving, at the graphics kernel, a second request from a second application operating in a host operating system on the computer device to use the hardware acceleration device, wherein the host operating system is different from the guest operating system; and
coordinating use of the hardware acceleration device between the first application and the second application by sharing data from the first application and the second application to the hardware acceleration device.

8. The method of claim 7, wherein the data from the first application and the second application is shared using direct mapping of the hardware acceleration device.

9. The method of claim 7, wherein the guest environment is a LINUX environment that includes an emulation of a LINUX graphics kernel.

10. The method of claim 7, wherein the guest environment is a LINUX environment that includes a virtual device that communicates directly with the graphics kernel using a set of function pointers.

11. The method of claim 10, wherein the set of function pointers are similar to function pointers applications on the host operating system use to communicate with the graphics kernel.

12. The method of claim 11, wherein the first request from the guest environment appears to the graphics kernel as a local process to the host operating system.

13. The method of claim 7, further comprising:
providing access to the hardware acceleration device to the first application to use the hardware acceleration device to perform graphics operations and simultaneously providing access to the hardware acceleration device to the second application to use the hardware acceleration device to perform local graphics operations.

14. The method of claim 7, wherein the hardware acceleration device is a graphics device or a compute device.

15. A computer device, comprising:
a memory;
a processor;
a hardware acceleration device;
a host operating system;
a guest environment that includes a guest graphics kernel running within a virtual machine hosted by the host operating system, wherein the guest environment includes a guest operating system is different from the host operating system; and
a graphics kernel operable to:
receive a first request from the guest environment to use the hardware acceleration device for graphics operations using the guest graphics kernel;
receive a second request from the host operating system to use the hardware acceleration device for local graphics operations; and
provide access to the hardware acceleration device to the guest environment to use the hardware acceleration device to perform the graphics operations and to the host operating system to use the hardware acceleration device to perform the local graphics operations.

16. The computer device of claim 15, wherein the guest environment is a LINUX environment and the graphics kernel is further operable to:
communicate with the guest graphics kernel using a communication channel to provide applications in the guest environment access to the hardware acceleration device.

17. The computer device of claim 16, wherein the communication channel allows the guest environment to run graphics workloads in the LINUX environment and the communication channel supports paravirtualization protocols.

18. The computer device of claim 15, wherein the guest graphics kernel is a LINUX graphics kernel that exposes a set of functions to communicate with the graphics kernel using paravirtualization protocols.

19. The computer device of claim 15, wherein the guest environment is a LINUX environment that includes:
a LINUX user mode with an application;
a graphics application programming interface (API);
a graphics service host; and
a user mode driver.

20. The computer device of claim 15, wherein the hardware acceleration device is a graphics device or a compute device.
